(19) United States
(12) Patent Application Publication
(10) Pub. No.: US 2020/0358663 A1
(43) Pub. Date: Nov. 12, 2020

(54) POST-EXPERIMENT NETWORK EFFECT ESTIMATION BASED ON LOGGED MESSAGING EVENTS

(71) Applicant: Microsoft Technology Licensing, LLC, Redmond, WA (US)

(72) Inventors: Guillaume Benjamin Saint-Jacques, Santa Clara, CA (US); James Eric Sorenson, Somerville, MA (US); Nanyu Chen, North Hollywood, CA (US); Ya Xu, Los Altos, CA (US)

(21) Appl. No.: 16/405,618

(22) Filed: May 7, 2019

(51) Int. Cl. H04L 12/24; H04L 12/58

(52) U.S. Cl. CPC H04L 41/22; H04L 51/32; H04L 51/34; H04L 51/16

(57) ABSTRACT

Computer-implemented techniques for ex post facto accounting for interference from network effects in a one-to-one messaging experiment in an online service. With the techniques, is not necessary to identify isolated, non-interacting communities of users pre-experiment. Instead, unconventionally, a total lift for the treatment feature may be computed post-experiment based on the observed actual messages sent during the experiment by users in the treatment and control groups. Techniques for post-experiment computation of an experiment-specific message response rate, based on observed messages sent, and post-experiment computation of an instant lift, based on overserved message sent, are also disclosed.

### TECHNICAL FIELD

The present disclosure generally relates to messaging applications of online services. More specifically, the present disclosure relates to computer-implemented techniques for post-experiment estimation of network effects in a messaging experiment in an online service based on logged records of messages sent during the experiment.

### BACKGROUND

Many online services release new features to end-users essentially continuously. Typically, when releasing a new feature, an online service does not release the new feature to all users of the online service at the same time. Instead, the new feature is released initially to just a subset of users. For example, the new feature may be released to a randomly selected subset of users.

The reason for the limited release of a new feature is to compare the efficacy of the currently used feature against the new feature. The existing or current feature is sometimes referred to as the “control feature” and the new, experimental feature is sometimes referred to as the “treatment feature.” Users exposed to the treatment feature are sometimes called the treatment group and users exposed to the control feature but not the treatment feature are sometimes called the control group.

User behavior influenced by the control feature and the treatment feature is observed during the testing period. And if the treatment feature proves to be effective in influencing a target user behavior, then the treatment feature may be released to all users and may even subsequently become the control feature for a subsequent feature release. This new feature testing strategy works well if the behavior of users using the treatment feature does not affect the behavior of users using the control feature.

Unfortunately, many online services have features that allow users to interact with one another using the service. For example, an online social networking service many provide a private messaging feature whereby a user can privately message another user of the service through the online service platform. In this case, the act of a user in the treatment group sending a message to a user in the control group may affect the behavior of the user in the control group such that the efficacy of the treatment feature versus the control feature is no longer sufficiently independent for evaluation purposes.

For example, consider a social networking online service that provides a one-to-one messaging application whereby a user can select a friend user and message that user privately through the service. Further consider the service wishing to release a new “presence” feature. With the presence feature, a graphical user interface icon representing a green light is presented next to a user's avatar when that user is online with the service. The service hopes that the presence feature will increase user engagement with the private messaging feature because the presence feature will allow users to see that a friend is online and available to receive and respond to messages quickly.

The service may initially release the presence feature to a randomly selected treatment group. However, a user Abe in the treatment group may have a friend Betty in the control group. Because of the presence feature, Abe may see that Betty is currently online and message her causing Betty to reply to Abe's message with a message of her own. Thus, Abe's user behavior, influenced by the presence feature, affected Betty's user behavior, who is not in the treatment group and not exposed to the presence feature. Since Abe and Betty's respective user behaviors are no longer independent, the efficacy of the treatment verses the control is no longer independent. This example illustrates an issue with the testing of new features for online social networking services, or other online services, that allow users to interact with each other through the service, that is sometimes referred to as interference by network effects.

Because of interference by network effects, the increased engagement of the treatment group because of the treatment feature may be masked (attenuated) to an extent by the increased engagement of the control group that is caused by the treatment group using the treatment feature to interact with the control group. As a result, the treatment feature does not appear to be as effective as it really is in increasing user engagement. It is also possible as a result of interference from networks effects for the treatment feature to appear to have a negative effect on user engagement when in fact it has a positive effect.

One possible approach to address interference by network effects is to select a treatment group such that the users in the treatment group are not likely to interact with users in the control group. In other words, instead of selecting users randomly for inclusion in the treatment group from among all users of the service, users are selected randomly from a community of users whose online user behavior with the service is primarily directed to other users within the same community.

One possible way to select a treatment group community is to model user interactions between users of the service with a graph. A graph partitioning algorithm (e.g., a normalized cuts algorithm) may then be applied to the graph to identify effectively isolated, non-interacting groups of users. This graph partitioning approach can be effective if past user interaction with the online service on which the graph is constructed is sufficiently predictive of future user interaction with the online service. However, this may not be the case for all types of user interaction or all online services. For example, the users that a particular user privately messaged in the past month using the online service may not be the same set of users the particular user will privately message in the upcoming month. Thus, pre-experiment identification of a sufficiently isolated and representative community of users for testing a new online service feature using the graph partitioning approach may be difficult. Thus, a solution is needed to more easily and more effectively account for interference by network effects in one-to-one messaging experiments.

The present invention addresses this and other needs.

The approaches described in this section are approaches that could be pursued, but not necessarily approaches that have been previously conceived or pursued. Therefore, unless otherwise indicated, it should not be assumed that any of the approaches described in this section qualify as prior art, or are well understood, routine, or conventional, merely by virtue of their inclusion in this section

### BRIEF DESCRIPTION OF THE DRAWINGS

In the drawings:

FIG. 1A depicts an example treatment feature of an online service, according to an implementation of the present invention.

FIG. 1B depicts an example treatment feature of an online service, according to an implementation of the present invention.

FIG. 1C depicts an example treatment feature of an online service, according to an implementation of the present invention.

FIG. 2 is a flowchart of a high-level process for ex post facto accounting for interference for network effects in a one-to-one messaging experiment in an online service, according to an implementation of the present invention.

FIG. 3 depicts a taxonomy of message classes by treatment status of sender and recipient, according to an implementation of the present invention.

FIG. 4 depicts a directed edge of a graph for post-experiment variance estimation, according to an implementation of the present invention.

FIG. 5 is example Scala code implementing a hash function for consistently assigning a treatment status to a user during an iteration of a target a variance estimation permutation, according to an implementation of the present invention.

FIG. 6 depicts a graphical user interface that may be presented to a user of a computing system, according to an implementation of the present invention.

FIG. 7 is graphical user interface explaining confidence intervals as a result of variance estimation, according to an implementation of the present invention.

FIG. 8 is a block diagram that illustrates a computer system upon which an embodiment of the invention may be implemented

### DETAILED DESCRIPTION

In the following description, for the purposes of explanation, numerous specific details are set forth in order to provide a thorough understanding of possible implementations of the present invention. It will be apparent, however, that an implementation may be practiced without these specific details. In other instances, well-known structures and devices are shown in block diagram form in order to avoid unnecessarily obscuring an implementation.

### Terminology

The following definitions are provided for purposes of illustration, not limitation, to aid in understanding the discussion that follows:

Affinity: The term “affinity” refers generally to a preference or lack of preference of users in the treatment group to engage in the target user behavior with other users in the treatment group as a result of being exposed to the treatment feature as compared to engaging in the target user behavior with users in the control group.

Control Group: The “control group” is a group or community of users that is not exposed to the treatment feature under test.

Lift: The term “lift” refers generally to an increase or decrease in the target user behavior as a result of being exposed to the treatment feature. More generally, lift is a measurement in the change of metric or measurement of interest from a base state. It is an indicator of effective new feature performance, and is important for decision making.

Online Service: The term “online service,” which is sometimes referred to as “Software as a Service (SaaS),” broadly refers to a service provided by a software application running online and offering its facilities to users over the Internet or other data communications network via a graphical user interface presented at the users' computing devices. For example, the interface may include HyperText Markup Language (HTML) presented by a web-browser application or a mobile application executing at the users' computing device.

Online Social Networking Service: The term “online social networking service” refers to an online service as defined above where the application running online maintains data representing users of the online social networking service and connections and relationships between the users in the network. For example, an online social networking service may provide facilitates for users to establish and stay in contact with their friends and family. Another example is an online social networking service that caters of businesses and professionals by providing a platform to meet career peers and influential people in industry.

Ramp Percentage: The term “ramp percentage” refers to a percentage of users selected for inclusion in the treatment group or a percentage of users exposed to the treatment feature.

Spillover: The term “spillover” refers to a change in user behavior of users in the control group that is caused by the target user behavior of users in the treatment group from being exposed to the treatment feature.

Treatment Feature: The “treatment feature,” sometimes referred to as the “new feature” or the “experimental feature,” is the feature under test intended to influence the target user behavior.

Treatment Group: The “treatment group” is a group or community of users that are exposed to the treatment feature under test.

Target User Behavior: The term “target user behavior” or just “target behavior” refers to the user behavior under test that the treatment feature is intended to influence. For example, the target user behavior may be sending messages using a one-to-one messaging application of the online service.

### General Overview

Computer-implemented techniques for ex post facto accounting for interference from network effects in a one-to-one messaging experiment in an online service are disclosed. With the techniques, is not necessary to identify isolated, non-interacting communities of users pre-experiment. Instead, unconventionally, a total lift for the treatment feature may be computed post-experiment based on the observed actual messages sent during the experiment by users in the treatment and control groups. Techniques for post-experiment computation of an experiment-specific message response rate, based on observed messages sent, and post-experiment computation of an instant lift, based on overserved messages sent, are also disclosed.

In an implementation, for example, a graphical user interface that includes a treatment feature is presented during a one-to-one messaging experiment to treated users of the online service that are selected for inclusion in a treatment group of the experiment. Also during the experiment, a graphical user interface that includes a control feature and that does not include the treatment feature is presented to control users of the online service that are selected for inclusion in a control group of the experiment. During the experiment, records of messages sent through the online service using a one-to-one message application are logged. Post-experiment, a total lift of the treatment feature is estimated based on the number of logged messages sent between treated users in the treatment group and the number of logged messages sent between control users in the control group.

Because the total lift is computed post-experiment based on the records logged about messages sent during the experiment, pre-experiment identification of isolated, non-interacting communities of users is not required to estimate a lift of the treatment feature. These conserves computing resources (e.g., processor, data storage, and data center cooling/energy resources) that might otherwise have been required pre-experiment to identify the isolated, non-interacting communities of users. This conservation of computing resources is especially useful at large-scale such as in the large-scale online service context where substantial computing resources may be needed to identify isolated, non-interacting communities of users among millions or even billions of users.

While the techniques disclosed herein do not require pre-experiment identification of isolated, non-interacting communities of users, the techniques are not exclusive of such pre-experiment identification. Thus, the techniques disclosed herein may be used in conjunction with, or instead of, existing techniques for accounting for interference from network effects in the one-to-one messaging experiment in the online service.

### Treatment Feature

In an implementation, the total lift is computed as the lift of the treatment feature on the target user behavior if the treatment feature were to be exposed to all users in the treatment group and the control group. The treatment feature can be intended to influence the target user behavior either positively or negatively. If the treatment feature is intended to influence the target user behavior positively, then the target user behavior is expected to increase (e.g., by rate or number of occurrences) when users are exposed to the treatment feature (positive lift). On the other hand, if the treatment feature is intended to influence the target user behavior negatively, then the target user behavior is expected to decrease when users are exposed to the treatment feature (negative lift). For example, the presence feature discussed in the Background section above may be intended to positively influence the target user behavior of sending private messages via an online service platform.

In the context of the online service, the treatment feature can take a variety of different forms. One possible form that the treatment feature can take in the context of the online service is a particular configuration of a graphical user interface to the online service. The graphical user interface may be caused to be presented by the online service to a user of the online service at the user's personal computing device. The online service may cause the graphical user interface to be presented at the user's personal computing device by sending information and data to the user's personal computing device over a data communications network from a server operated by or invoked by the online service to send the information and data. A client application executing at the user's personal computing device may receive the information and data sent from the server and use the information and data to present the graphical user interface on a video display screen of, or operatively coupled to, the user's personal device. The client application may be a web browser client application or a mobile client application, for example.

The particular configuration of the graphical user interface that is the treatment feature may take a variety of different visual forms and no particular form is required of an implementation. For example, the particular configuration of the graphical user interface may encompass all of the following visual elements, a superset of these visual elements, or a subset of a superset: particular text that is displayed, the size of the text, the font of the text, the coloring of the text, the position of the text in the graphical user interface, a particular graphical user interface icon that is displayed, the size of the icon, the position of the icon in the graphical user interface, the coloring of the icon, if and how the icon responds to user input, a particular graphical user interface pop-up dialog that is displayed, the size of the pop-up dialog, the content of the pop-up dialog, the modality of the pop-up dialog, if and how the icon responds to user input, a particular graphical user interface overlay that is displayed, the size of the overlay, the position of the overlay in the graphical user interface, the content of the overlay, if and how the overlay responds to user input, or other features and functions of the graphical user interface, including a combination of features and functions.

In this description, reference is made to a user, as in a user of an online service. The user may be identified to the online service via an authentication process (e.g., a process that authenticates username and password credentials). As a result of the authentication process, a user account for the user may be identified and operations carried out by the online service on behalf of the user for the user account in the context of the user account. For example, a graphical user interface may be presented by the online service to the user for the user account at the user's personal computing device, or a message may be sent by a user from one user account to another user account of a different user. Thus, without loss of generality, reference herein to user/s may be substituted with user account/s, unless the context clearly indicates otherwise.

### Example Treatment Features

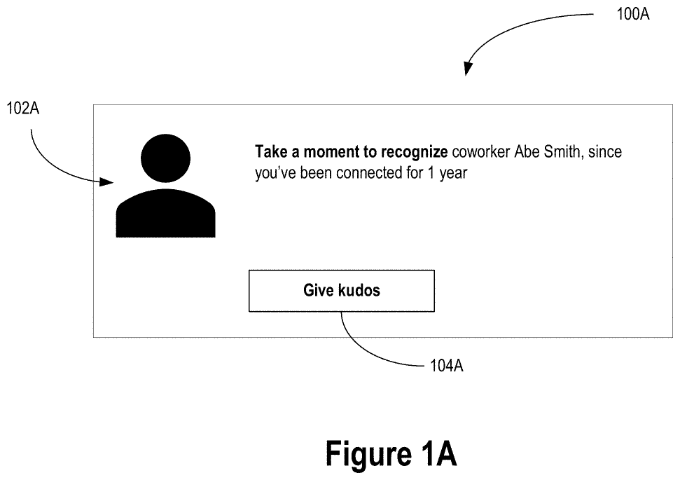

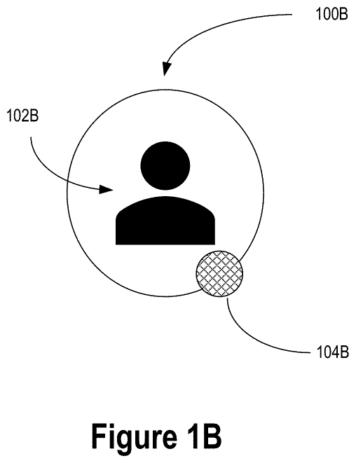

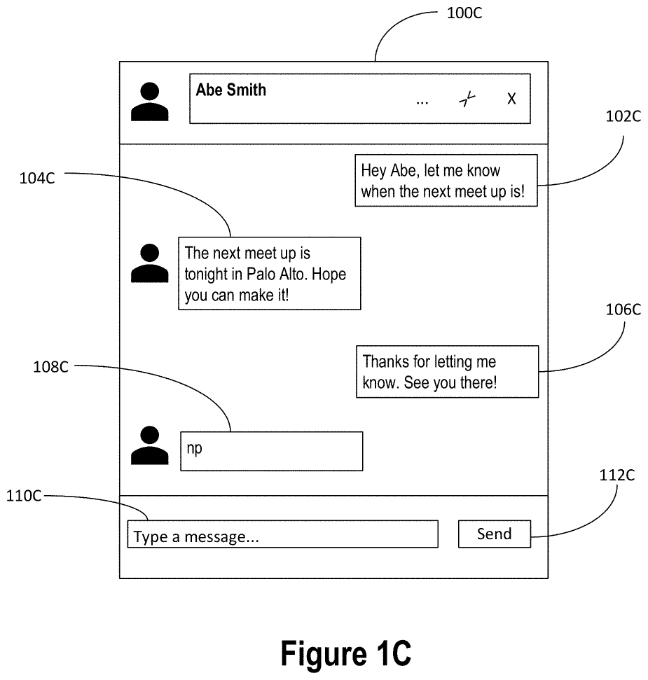

FIG. 1A depicts example treatment feature 100A, according to an implementation of the present invention. In this example, treatment feature 100A is a graphical user interface pop-up dialog that is displayed to a particular authenticated user of an online social networking service. Treatment feature 100A informs the authenticated user that one of the user's connections in the social network, Abe Smith, has been in a co-working relationship in the social network with the authenticated user for one year. Treatment feature 100A includes an image or avatar 102A of Abe and a graphical user interface button 104A that invites the authenticated user to send a kudos message via the social networking service to Abe for being a co-worker connection in the social network with the authenticated user for one year. During the one-to-one messaging experiment, treatment feature 100A, or the like, may be presented to users in the treatment group but not to users in the control group. While in the example of FIG. 1A, treatment feature 100A pertains to an online social network connection anniversary, treatment feature 100A could just as easily pertain to another type of event or milestone, inside or outside an online social network, such as, for example, a birthday, a work anniversary, a marriage anniversary, a friend connection anniversary in an online social network, an anniversary of holding a user account with an online social network, etc.

FIG. 1B depicts example treatment feature 100B, according to an implementation of the present invention. In this example, treatment feature 100B is a graphical user interface element that is displayed to a particular authenticated user of an online social networking service. Treatment feature 100B informs the authenticated user of a current presence status of one of the user's connections in the online social network. Treatment feature 100B includes an image or avatar 102B of the authenticated user's connection. Treatment feature 100B also includes a presence indicator 104B that indicates whether the user's connection is currently using the online social networking service. For example, presence indicator 104B may be colored green when the user's connection is currently online with the social network service and colored grey when the user's connection is not currently online with the social networking service. During the one-to-one messaging experiment, treatment feature 100B, or the like, may be presented to users in the treatment group but not to users in the control group.

FIG. 1C depicts example treatment feature 100C, according to an implementation of the present invention. In this example, treatment feature 100C is a graphical user interface chat messaging overlay that is displayed to a particular authenticated user of an online service that includes live chat capabilities. Treatment feature 100C may be presented in the graphical user interface as an overlay to other content provided by the online service such as, for example, a social networking feed or other content provided by the online service. Treatment feature 100C allows the authenticated user to conduct a live chat dialog with another user of the online service, in this example a user named Abe Smith. The authenticated user initiates the chat conversation with a first chat message 102C. Abe responds with a second chat message 104C. The authenticated user replies with a third chat message 106C which is acknowledged by Abe with a fourth chat message 108C. Treatment feature 100C allows the authenticated user to send an additional chat message to Abe by entering the message into message box 110C and activating send button 112C. During the one-to-one messaging experiment, treatment feature 100C, or the like, may be presented to users in the treatment group but not to users in the control group. While in the example of FIG. 1C, treatment feature 100C pertains to a social chat conversation between acquaintances, treatment feature 100C could just as easily pertain to another type of chat conversation such as, for example, a conversation between a customer and an online help support person or a conversation between a patient and a doctor, as just some examples.

Treatment features 100A, 100B, and 100C of FIG. 1A, FIG. 1B, and FIG. 1C, respectively, are merely examples of possible treatment features. An implementation is not limited to any particular treatment feature for the one-to-one messaging experiment. A wide-variety of different treatment features may be used in different implementations including those that vary depending on the type of online service and according to the requirements of the particular implementation at hand.

Generally, the techniques disclosed herein for ex post facto accounting for interference from network effects in one-to-one message experiments in an online service can be used determine the total treatment effect (total lift) and the experiment-specific message response rate of virtually any treatment feature intended to influence the sending of messages between users of an online service using one or more one-to-one messaging applications of the online service. Such a one-to-one messaging application may include, but is not limited to, a chat application, a commenting application, an online dating application, an online help-support application, or any other online application of an online service that allows a user to send a message through the online service to another user of the service.

It should also be noted that multiple one-to-one messaging applications of an online service may be involved in the one-to-one messaging experiment. Thus, the techniques disclosed herein are not limited to one-to-one messaging experiment involving only a single one-to-one messaging application, or any particular type of one-to-one messaging application.

### Target User Behavior

In an implementation, the target user behavior that the treatment feature is intended to influence involves the sending of messages using one or more one-to-one messaging applications of the online service. One-to-one messaging may involve a user of the service using the online service to send a message through the service that is intended by the sending user to be received by one or more other specifically identifiable users of the online service.

In sending the message, the intended recipient users may be expressly specified by the sending user or the intended recipients may be implied in context. For example, intended recipient users may be expressly specified by the sending user using identifiers of the intended recipient users (e.g., user identifiers, user names, e-mail addresses, etc.) The intended recipient users may be implied. For example, if a user Abe enters a chat message into a chat messaging dialog for a chat message conversation between user Abe and user Betty, then user Betty is the implied recipient user of user Abe's chat message. Similarly, if user Abe adds a comment to an online word processing document to which user Abe, user Betty, and user Chris have all been invited, then user Betty and user Chris are the implied recipient users of user Abe's comment.

A message sent can have more than one intended recipient user. For example, the online word processing document comment example above is an example of a sent message that has more than one intended recipient user. In this case, for purposes of the one-to-one messaging experiment, the message sent may be viewed as multiple one-to-one messages with the same content where each such one-to-one message is sent from the sending user and intended for a single one of the intended recipient users.

Returning to the comment example above, Abe's comment may be viewed as two one-to-one messages, one message sent from Abe intended for Betty and another message sent from Abe intended for Chris. Accordingly, as meant hereinafter, the term “message,” as in a sent message, refers to a one-to-one message sent by a sending user that is intended for a single recipient user.

A message can take a variety of different forms depending on the online service and according to the requirements of the particular implementation at hand. For example, a message can be a chat message, an electronic mail message, a comment, a post, or other message with text and/or media content.

While in an implementation the target user behavior involves sending messages with text and/or media content, a message may take other forms in other implementations. For example, a user may send a message to another user by activating or deactivating a graphical user interface icon or set of icons that appears to a receiving user in its activated or deactivated state as selected by the sending user. For example, the graphical user interface icon or set of icons may be a thumbs up, thumbs down, up vote, down vote, star rating, like, follow, or other graphical user interface icon or set of icons intended to convey a message (e.g., a sentiment of a user) to a viewer when activated or deactivated.

### Standard Lift

A goal of the one-to-one messaging experiment may be to accurately determine the lift of the target user behavior caused by exposing users to the treatment feature. The lift may be measured in terms of a relevant metric. For example, for the one-to-one messaging experiment, the lift may be measured in terms of the number of messages sent. More generally, the lift in a metric induced by the treatment feature may be defined as the percentage difference between two measurements that cannot be observed contemporaneously: (1) the value of the metric if all users in the treatment and control group were exposed to the treatment feature, and (2) the value of the metric if none of those users were exposed to the treatment feature. As mentioned, determining lift for one-to-one messaging experiments is complicated by interference from network effects.

For other experiments not involving one-to-one messaging, accurately determining a standard lift can be relatively straightforward. For example, outside the one-to-one messaging context, when testing whether users are more likely to click a graphical user interface button if the button is yellow (treatment feature) or if the button is blue (control feature), the standard lift can be determined as the standardized difference between the number of user input activations (e.g., clicks) of the treatment feature button by users in the treatment group and the number of user input activations of the control feature button by users in the control group. The number of user input activations of the treatment feature button by users in the treatment group represents what users do when they are exposed to the treatment feature (e.g., the yellow button), and the number of user input activations of the control group button by users in the control group represents the counterfactual—what users would do if there were no treatment feature button. In this case, the standard lift may be accurately determined based on a comparison of the observed effect of treatment and the counterfactual from the control group.

### Interference from Network Effects—Spillover

However, as indicated elsewhere herein, when the target user behavior is directed to other users such as in the one-to-one messaging experiment, then the target user behavior of users in the treatment group may change the behavior of the users in the control group. As such, the lift cannot be accurately determined simply by measuring the change in the number of messages sent by users in the treatment group relative to the control group. This is because messages sent by users in the treatment group may be received by users in the control group causing those users in the control group to, in turn, send messages that might not otherwise have been sent had the treatment group not been exposed to the treatment feature. As result, the number of messages sent by users in the control group does not accurately represent what users would do if there were no treatment feature.

For example, if a user Abe in the treatment group sends a message to a user Betty in the control group to initiate a conversation, then there is a likelihood that user Betty will reply to Abe's message with a message of her own. If Abe's initial message was sent because Abe was exposed to the treatment feature, then it can no longer be assumed that the users in the control group are behaving as if there is no experiment being conducted. In other words, the one-to-one messaging experiment can have spillover, which is a form of interference from network effects.

### Interference from Network Effects—Affinity

In an implementation, in addition to spillover, another type of interference from network effects is accounted for in an ex post facto manner. This type of interference from network effects is referred to herein as affinity. As used herein, the term “affinity” refers to a preference or lack of preference of users in the treatment group to engage in the target user behavior with other users in the treatment group as a result of being exposed to the treatment feature as compared to engaging in the target user behavior with users in the control group.

For example, affinity, as determined according to techniques disclosed herein, may reflect whether users in the treatment group are likely to send more messages to any other user of the online service because of being exposed to the treatment feature, or whether the users in the treatment group are likely to send more messages to other users of the treatment group as compared to sending messages to users in the control group.

### High-Level Process

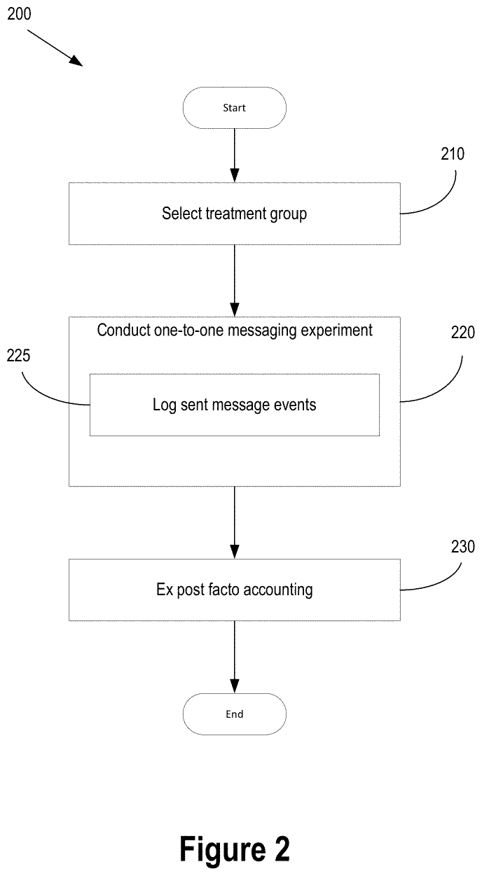

FIG. 2 depicts flowchart 200 of a high-level process for ex post facto accounting for interference from network interfaces in a one-to-one messaging experiment with users of an online service, according to an implementation of the present invention. The process includes the steps of selecting a treatment group 210, conducting the one-to-one messaging experiment 220 including logging sent message events 225, and, after conducting 220 the one-to-one messaging experiment, accounting 230 for interference from network effects based on the logged 225 sent message events.

Returning to the top of the process, a treatment group is selected 210. As mentioned, it is not necessary to identify an isolated community of users as the treatment group. Although selection of such a community as the treatment group is not prohibited. Instead, standard Bernoulli sampling or other user-level randomization scheme may be used to select the treatment group. Standard Bernoulli sampling or other user-level randomization scheme may be used to select the treatment group even though the one-to-one messaging experiment may have interference from network effects such as spillover and/or affinity. An accurate total lift of the treatment feature may be computed post-experiment even though standard Bernoulli sampling or other user-level randomization scheme is used to select the treatment group.

In an implementation, less than one-hundred percent (100%) of the available users for inclusion in the treatment group are selected 210. For example, only five percent (5%), ten percent (10%), twenty-five percent (25%), or fifty (50%) percent of the available users may be selected for inclusion in the treatment group. This may be done to constrain any potential or unforeseen negative user experience caused by the treatment feature to a smaller set of users. In an implementation, the percentage of available users that are selected for inclusion in the treatment group is referred to herein as the “ramp percentage.”

At step 220, the one-to-one messaging experiment is conducted. It should be noted that steps 210 and 220 can be performed at least partially concurrently, or step 210 can be performed entirely before step 220 is started. For example, users can be selected 210 for inclusion in the treatment group as the one-to-one messaging experiment is being conducted 220. Alternatively, the treatment group may be selected 210 entirely before initiating conducting 220 the one-to-one messaging experiment such that the set of users included in the treatment group are predetermined before conducting 220 the experiment.

The one-to-one messaging experiment may be conducted 220 with respect to the treatment feature. While the one-to-one messaging experiment is being conducted 220, users in the treatment group are exposed to the treatment feature and users in the control group are not exposed to the treatment feature. Also, while the one-to-one messaging experiment is being conducted 220, sent message events are logged 225 by the online service in a computer storage media. Each logged sent message event is for a message sent by a user in the treatment group or the control group using a one-to-one messaging application of the online service. A record of the sent message event may be stored for the message in the computer storage media.

The record stored for a message may include information from which it can be determined whether the message was sent from a user in the treatment group to another user in the treatment group (referred to hereinafter as “TtoT”), whether the message was sent from a user in the treatment group to a user in the control group (referred to hereinafter as “TtoC”), whether the message was sent from a user in the control group to another user in the control group (referred to hereinafter as “CtoT”), or whether the message was sent from a user in the control group to a user in the treatment group (referred to hereinafter as “CtoC”).

For example, the record may include a pair of user identifiers identifying the sending user and an intended recipient user of the message. The user identifiers may be anonymized for privacy or other like purposes. The user identifiers may be used post-experiment to determine whether the sending user and the intended recipient user is in the treatment group or the control group with respect to the message. For example, the user identifiers may be used as a key to a suitable data structure that reflects the assignments of users to the treatment and control groups. As an alternative, the record stored for a message may specify directly whether the message is TtoT, TtoC, CtoT, or CtoC.

The one-to-one messaging experiment may be conducted 220 for a period of time during which sent message events are logged 225. For example, the period of time may be days, weeks, months, or other period of time suitable to the particular one-to-one messaging experiment at hand.

While the one-to-one messaging experiment may be conducted 220 for a predetermined period of time (e.g., three months), the one-to-one messaging experiment may also be conducted 220 so long as there are still users in the treatment group who have not yet been exposed to the treatment feature, or have not yet been exposed to the treatment feature at least a threshold number of times (e.g., not exposed to the treatment feature in at least three different user sessions). A combination of termination conditions is also possible. For example, the one-to-one messaging experiment may be conducted 220 for up to a predetermined period of time but stop sooner if each user in the treatment group has been exposed to the treatment feature at least a threshold number of times and each user in the control group has been exposed to the one-to-one messaging feature at least a threshold number of times.

It should be noted that a sent message event may be logged 225 for a message even if the message is not received by the intended recipient user. Thus, a message may be considered to be sent and logged 225 as such if the online service delivers the message to the intended recipient user but the intended recipient user does not actually receive the message. For example, the online service may place the message in a message queue for the intended recipient user, but the intended recipient user may never actually subsequently use the online service such that the message is retrieved from the message queue and presented to the intended recipient user in a graphical user interface. In other implementations, a message is sent and logged 225 as such only if the message is presented to the intended recipient user in a graphical user interface.

After the one-to-one messaging experiment is conducted 220, an ex post facto accounting 230 for interference from network effects is computed. Among other things, a total lift of the treatment feature is computed based on the sent message events logged 225 while the one-to-one messaging experiment was conducted 220. The total lift represents the lift of the treatment feature if it were to be exposed to all users in the treatment group and the control group. The total lift is computed such that spillover and affinity caused by the one-to-one messaging experiment are accounted for. As a result, the total lift more accurately reflects the lift of the treatment feature compared to the standard lift.

It should be noted that users in the treatment group may continue to be exposed to the treatment feature after the one-to-one messaging experiment has been conducted. For example, another instance of the one-to-one messaging experiment may have been started after the current instance has completed. Thus, there is no requirement that the treatment feature cease being exposed to the treatment group after an instance of the one-to-one messaging experiment has been conducted. The messages logged 225 during the current instance of the one-to-one messaging experiment may reflect only messages sent during the current instance and not reflect any messages sent during a prior or subsequent instance of the experiment.

### Total Lift

As indicated elsewhere herein, an aspect of the one-to-one-messaging experiment is that the target user behavior is the sending of messages via a one-to-one messaging application of the online service. Such behavior may involve two users per message: the message sender and the message recipient. In an implementation, for each message sent via a one-to-one messaging application during the experiment, the treatment status (i.e., treatment or control) of the message sender and the treatment status of the message recipient may be logged 225 or determined based on the logged 225 events.

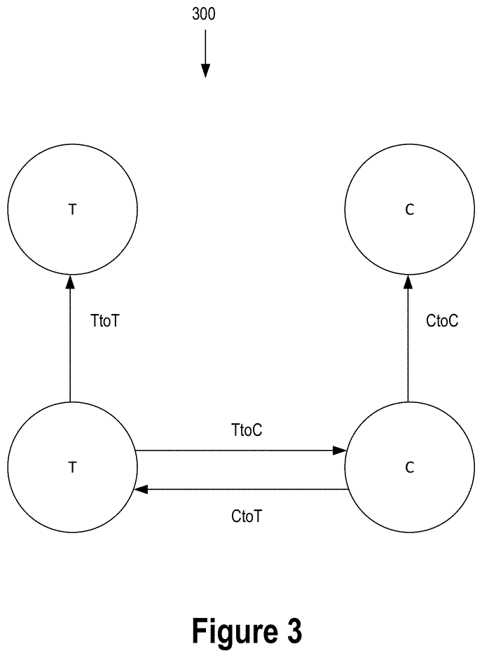

FIG. 3 depicts taxonomy 300 of message classes by treatment status of sender and recipient, according to an implementation of the present invention. A message can be sent from a first treatment user as the sender and received by a second treatment user as the recipient (TtoT). A message can be sent from a first treatment user as the sender and received by a first control user as the recipient (TtoC). A message can be sent from a first control user as the sender and received by a first treatment user as the recipient (CtoT). A message can be sent from a first control user as the sender and received by a second control user as the recipient (CtoC).

In an implementation, messages sent via a one-to-one messaging application of the online service are each classified into one of four classes based on the logged 225 events: messages from a treated user to another treated user (class TtoT), messages from a treated user to a control user (class TtoC), messages from a control user to a treated user (class CtoT), and messages within the control group (CtoC).

Computing the total lift may be based on the logged 225 sent message events. In particular, because of the logged sent message events, it can be determined which messages sent during the experiment are TtoT and which are CtoC. The total lift can be computed based on a comparison between the number of TtoT messages and the number of CtoC messages, normalized for the ramp percentage. This ability to compute the total lift based only on the number of TtoT messages and the number of CtoC messages, ignoring the number of TtoC messages and the number of CtoT messages, stems from an assumption that the user behavior of users in the control group is affected by the target user behavior of users in the treatment group during the one-to-one messaging experiment only by receiving TtoC messages, and not by the sending or receiving of TtoT, CtoT, or CtoC messages.

In an implementation, the total lift is computed post-experiment, based on the events logged 225 during the experiment, in accordance with the following formula:

$$Total Lift = \frac{\frac{1}{{R}^{2}} \times {M}_{T T}}{\frac{1}{{( 1 - R )}^{2}} \times {M}_{CC}}$$

Here, the parameter M_{TT} represents the number of messages sent TtoT during the experiment and the parameter M_{CC} represents the number of messages sent CtoC during the experiment.

In other words, the total lift may be computed as the ratio of the number of TtoT messages sent during the experiment over the number of CtoC messages sent during experiment, normalized for the ramp percentage. The parameter R represents the ramp percentage (e.g., 0.25 for twenty-five (25%) percent). Normalization for the ramp percentage is performed to account for the possibility that the ramp percentage is less or greater than fifty percent (50%). In that case, a user in the treatment group has fewer or more fellow users in the treatment group to send messages to when compared to a user in the control group. Thus, the total lift may be normalized for the ramp percentage in the case the ramp percentage is less than or greater than fifty percent (50%). In the case that the ramp percentage is fifty percent (50%), then the total lift may be computed as simply the ratio of the number of TtoT messages sent during the experiment over the number of CtoC messages sent during experiment.

In an implementation, the total lift is computed as a difference between (1) the number of TtoT messages sent during the experiment and (2) the number of CtoC messages sent during experiment, normalized for the ramp percentage parameter R. For example, the total lift may be computed post-experiment, based on the events logged 225 during the experiment, in accordance with the following formula:

$$Total Lift = ( \frac{1}{{R}^{2}} \times {M}_{T T} ) - ( \frac{1}{{( 1 - R )}^{2}} \times {M}_{C C} )$$

This difference may be expressed as a percentage by dividing the difference by the normalized number of messages sent CtoC and then multiplying by 100. In other words, the total lift may be computed as a percentage according to the following formula:

$$Total Lift = \frac{( ( \frac{1}{{R}^{2}} \times {M}_{T T} ) - ( \frac{1}{{( 1 - R )}^{2}} \times {M}_{C C} ) )}{( \frac{1}{{( 1 - R )}^{2}} \times {M}_{C C} )} \times 100$$

It should be noted that the total lift, in either case above, can be computed post-experiment as a function of observable events that occurred during the experiment. In particular, as a function of observable messages sent ToT and messages sent CtoC. This computation relies on an assumption that the exposure to the treatment feature to the treatment group does not cause extra messages sent CtoC (within the control group), although such exposure may cause extra messages sent ToT (within the treatment group), ToC (from the treatment group to the control group), and CtoT (from the control group to the treatment group). In this description, reference to an “extra” sent message refers to a message sent during the experiment that would not have been sent but for the exposure of the treatment feature to users in the treatment group.

### Experiment-Specific Response Rate

It may be the case during the experiment that the treatment feature causes users in the treatment group to send extra messages to users in the control group than they would not send if the users in the treatment group were not exposed to the treatment feature. In turn, these extra TtoC messages may cause users in the control group to reply to those extra TtoC messages thereby causing extra CtoT messages. Overall, different one-to-one messaging experiments may induce users in both the treatment group and the control group to send different types of extra messages, and some of those extra messages may be more likely to elicit extra response messages from their recipient users than others.

In an implementation, in addition to determining the total lift of the treatment feature, an experiment-specific response rate is determined post-experiment based on the events logged 225 during the experiment. The determination is based on users in the treatment group sending extra messages to users in the control group. This affects the total number of TtoC messages. In reply, users in the control group may respond to these extra ToC messages, which will affect the total number of CtoT messages. However, these extra messages should not affect the total number of CtoC messages.

Stated otherwise, in an implementation, a normalized difference (normalized for the ramp percentage R) of the number of messages sent TtoC and the number of messages sent CtoC is taken as the number of extra messages sent TtoC. A normalized difference of the number of messages sent CtoT and the number of messages sent CtoC is taken as the number of extra response messages that were created as a result of the extra message sent TtoC. The response rate may then be computed as a ratio of the number of extra response messages sent CtoT over the number of extra messages sent TtoC.

In an implementation, the experiment-specific response rate a is computed based on the observable logged 225 events as follows:

$$α = \frac{{M}_{C T} - \frac{R}{( 1 - R )} {M}_{C C}}{{M}_{T C} - \frac{R}{( 1 - R )} {M}_{C C}}$$

Here, the parameter M_{CT} represents the number of observed messages sent during the experiment CtoT. Similarly, the parameter M_{CC} represents the number of observed messages sent during the experiment CtoC and the parameter M_{TC} represents the number of observed messages sent during the experiment TtoC. The parameter R is the ramp percentage.

### Instant Lift

In an implementation, in addition to an estimated the total lift, an instant lift is computed post-experiment based on the observed events logged 225 during the experiment. The instant lift is based on the number of extra messages sent within the treatment group during the experiment (q1) and the number of extra messages sent from the treatment group to the control group during the experiment (q2). If the number of extra messages sent within the treatment group (q1) exceeds the number of extra messages sent from the treatment group to the control group (q2), then there is affinity in that the treated users exhibited a preference during the experiment for other treated users over control users with respect to sending messages. There is also affinity if the number of extra messages sent from the treatment group to the control group (q2) exceeds the number of extra messages sent within the treatment group (q1). In this case, the treated users exhibited a preference for control users over other treatment users with respect to sending messages.

In an implementation, the instant lift is computed post-experiment, based on the observed events logged 225 during the experiment, according to the following formula:

$$Instant Lift = \frac{( {M}_{C C} {R}^{2} - {M}_{T T} {R}^{2} + 2 R {M}_{T T} - {M}_{T T} ) ( {M}_{C T} - {M}_{T C} ) ( R - 1 )}{( {M}_{C C} R + R {M}_{T C} - {M}_{T C} ) ( {M}_{C C} {R}^{2} )}$$

Here, the parameter M_{CC} represents the number of observed messages sent CtoC during the experiment, the parameter M_{TT} represents the number of observed messages sent ToT during the experiment, the parameter M_{CT} represents the number of observed messages sent CtoT during the experiment, and M_{TC} represents the number of observed messages sent ToC during the experiment. The parameter R represents the ramp percentage.

### Variance Estimation

In an implementation, the significance of the results of the one-to-one messaging experiment is gauged post-experiment. In particular, a permutation method is used to generate non-parametric confidence intervals for each of one or more of: the total lift, experiment-specific response rate, and instant lift estimated computed for the actual experiment based on the treatment group and control group assignments. In an implementation, three different types of target permutations are used post-experiment: (1) full permutation, (2) sender-side permutation, and (3) recipient-side permutation.

To enable the permutations, a graph may be constructed based on the events logged 225 during the experiment. The graph may be constructed based on all events logged 225 including for all messages sent by users in the treatment group and the control group during the experiment. The graph may be a directed graph having nodes and directed edges between the nodes. The graph may be represented in a computer storage media using a suitable data structure (e.g., an adjacency list).

Each node of the graph corresponds to a user in the treatment group or a user in the control group. Associated with each node is an identifier of the corresponding user and a boolean value indicating whether the user is considered to be in the treatment group or the control group for the target permutation. A directed edge from one (source) node to another (destination) node is associated with the number of messages sent during the experiment from the user corresponding to the source node to the user corresponding to the destination node. This number of messages may be determined from the events logged 225 during the experiment.

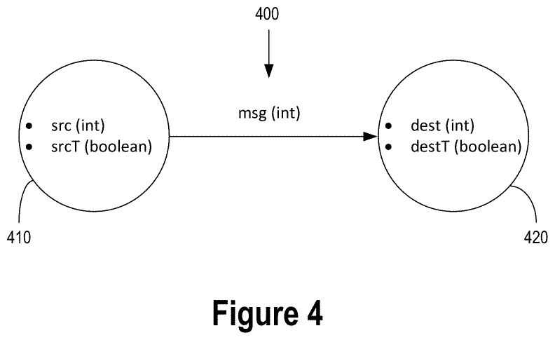

FIG. 4 provides an example of directed edge 400. Directed edge 400 is from source node 410 to destination node 420. Source node 410 is associated with an attribute src which is an integer data type value identifying the user corresponding to source node 410. Source node 410 is also associated with a Boolean attribute srcT that specifies the treatment status of the corresponding user for the target permutation—whether the corresponding user is in the treatment group or the control group for the target permutation. Likewise, destination node 420 is associated with an attribute src which is an integer data type value identifying the user corresponding to destination node 420. Destination node 420 is associated with a Boolean attribute destT that specifies the treatment status of the corresponding user—treatment or control. Directed edge 400 is associated with an integer-type attribute msg that specifies the number of messages sent during the experiment from the source user to the destination user.

Although not shown, the user corresponding to source node 410 may correspond to other source nodes for other directed edges in the graph (i.e., the user sent messages to other recipients during the experiment). Likewise, the user corresponding to source node 410 may correspond to destination nodes for other directed edges in the graph (i.e., the user received messages during the experiment.) Similarly, the user corresponding to destination node 420 may correspond to other destination nodes for other directed edges in the graph (i.e., the user received messages from other users during the experiment), or to source nodes for other directed edges in the graph (i.e., the user sent messages during the experiment).

With the full permutation, for each directed edge of the graph, for the purpose of classifying the messages corresponding to the directed edge in TtoT, TtoC, CtoC, or CtoT for an iteration of the full permutation, the treatment status of both the source user and the destination user is shuffled based on a non-cryptographic hash function.

With the sender-side permutation, for each directed edge of the graph, for the purpose of classifying the messages corresponding to the directed edge in TtoT, TtoC, CtoC, or CtoT for an iteration of the sender-side permutation, the treatment status of the destination user in the actual experiment is used, and the treatment status of the source user is shuffled based on a non-cryptographic hash function.

With the recipient-side permutation, for each directed edge of the graph, for the purpose of classifying the messages corresponding to the directed edge in TtoT, TtoC, CtoC, or CtoT for an iteration of the recipient-side permutation, the treatment status of the source user in the actual experiment is used, and the treatment status of the destination user is shuffled based on a non-cryptographic hash function.

In an implementation, the three permutations are performed in a network-consistent manner. In particular, within an iteration of a target permutation, the same treatment status for a user is consistently maintained for the iteration across all directed edges where the treatment status applies to the given user. For example, if a particular user is classified as a treatment user for the iteration, then the particular user is classified as a treatment user for all directed edges in the graph where the user is sender or the recipient. Likewise, if a user is classified as a control user.

In an implementation, to carry out an iteration of a target permutation, a large-scale distributed data processing system such as Apache Spark, MapReduce, or the like may be used. However, since treatment statuses are assigned per-user per-iteration, it may not be practical to pre-compute and store all treatment status assignments in computer storage media ahead of an iteration. Further, it may not be practical to communicate or otherwise coordinate treatment status assignments between distributed data processing nodes (e.g., Spark executors) of the distributed data processing system. Instead, treatment status assignments may need to be computed at each node in a consistent manner during the iteration without needing to communicate or coordinate with other nodes.

In an implementation, to facilitate computation of a consistent treatment status assignments to users during the execution of an iteration of a target permutation at a distributed data processing node of the distributed data processing system without requiring the node to communicate or coordinate with other nodes, a seed is concatenated with the user's identifier and an identifier of the current iteration of the target permutation. The result of the concatenation is then input to a non-cryptographic hash function. In an implementation, the current iteration of the target permutation is used as the seed in the concatenation and a separate seed is not used in the concatenation. The current iteration of the target permutation may be based on a monotonically increasing numerical value that is incremented by a fixed or variable numerical value for each iteration. The user identifier for a user may uniquely identify the user at least among all users that are a subject of the messages logged 225 during the experiment.

The output of the hash function is used to consistently assign the user to treatment or control during the iteration at each node of the distributed data processing where the user is assigned a treatment status. This concatenation gives a uniform treatment status assignment between treatment and control that is consistent across all directed edges the user is associated with as a sender (source) or a recipient (destination) for the iteration, without requiring data processing nodes of the distributed data processing system to communicate or coordinate with each other. In an implementation, the hash function used is the MurMurHash3 hash function, but other like non-cryptographic hash function may be used in another implementation.

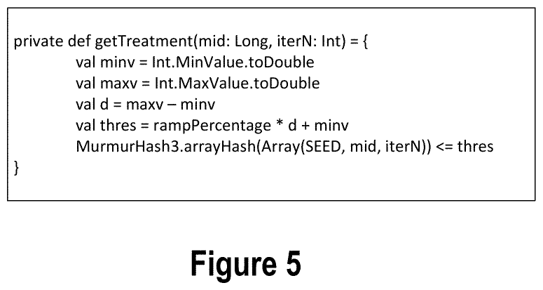

FIG. 5 is an example hash function implementation in the Scala programming language. The input parameters to the function are mid and interN, which may be named and/or typed otherwise in another implementation. The input parameter mid is the user's identifier. The input parameter interN is the current iteration number. The value of the mid parameter and the value of the interN parameter are concatenated to a seed value and input to a non-cryptographic hash function to determine whether the user is assigned to treatment or control for the iteration in accordance with the ramp percentage.

The three different target permutations allow for testing of different null hypotheses. For example, the full permutation may be used to test whether the treatment feature had any effect (lift) at all on the number of messages sent during the experiment. In that case (treatment feature has no effect), whether a user is assigned to treatment or control should not matter. Thus, the full permutation may be used in this case.

The sender-side permutation and the recipient-side permutation may be used to test for other network efforts, other than the expected effect that the treatment feature caused users in the treatment group to send extra messages during the experiment. For example, the recipient-side permutation may be used to test whether the users in the control group and users in the treatment group received a different number of extra messages during the experiment as a result of the treatment feature. In that case, whether the sender is assigned to treatment or control should matter, but the whether the recipient is assigned to treatment or control should not matter.

A target permutation may be performed for a number of iterations. For example, between one and ten thousand iterations of the target permutation may be performed. For each iteration, the total lift, the experiment-specific response rate, and the instant lift may be computed based on the treatment status assignments for users the iteration, which may be different from treatment and control assignments for the users during the actual experiment. In other words, for each iteration and across iterations, the messages sent during the experiment may be classified differently with respect to the ToT, TtoC, CtoC, and CtoT classes. After all of the iterations are performed, the variance of the total lift, experiment-specific response rate, and instant lift estimates across the iterations may be estimated and confidence intervals determined. The confidence intervals can be used to assess the significance of the total lift, experiment-specific response rate, and instant lift estimated for the actual experiment.

For example, if ten thousand iterations of the full permutation are performed, then ten thousand total lift calculations may be made, one for each iteration. The variance and confidential interval for the total lift estimated for the actual experiment may be determined based on the ten thousand total lift estimates computed for the ten thousand iterations of the full permutation.

### Example Graphical User Interfaces

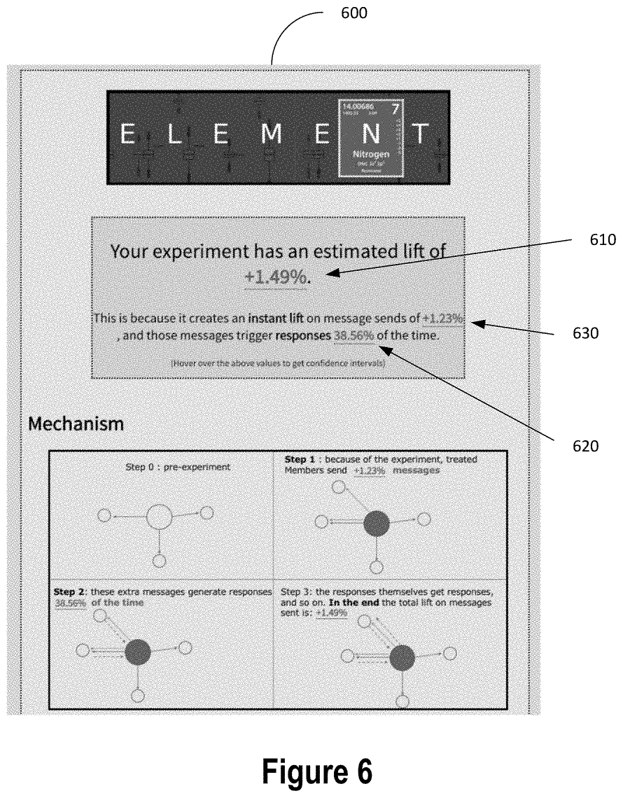

FIG. 6 depicts a graphical user interface (GUI) 600 that may be presented to a user of a computing system that implements the techniques disclosed herein, according to an implementation of the present invention. GUI 600 presents the results of a one-to-one messaging experiment where the estimated total lift 610 of the experiment, the estimated response rate 620, and the estimated instant lift 630 of the experiment are computed according to techniques disclosed herein.

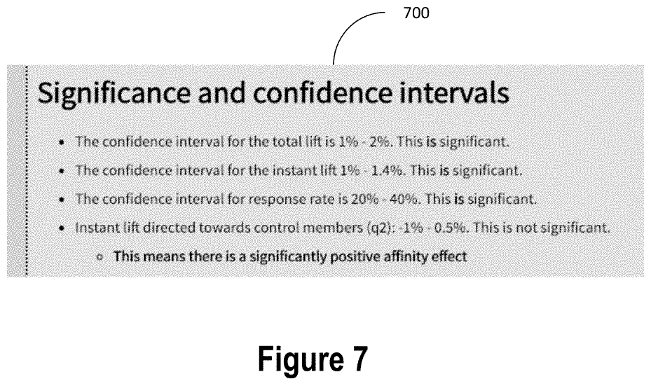

FIG. 7 is graphical user interface 700 explaining the confidence intervals as a result of variance estimation for the estimated total lift 610, as well as for the estimated response rate 620, and the estimated instant lift 630.

### Computing System Implementation

An implementation of the present invention may encompass performance of a method by a computing system having one or more processors and storage media. The one or more processors and the storage media may be provided by one or more computer systems. The storage media of the computing system may store one or more computer programs. The one or more programs may include instructions configured to perform the method. The instructions may also be executed by the one or more processors to perform the method.

An implementation of the present invention may encompass one or more non-transitory computer-readable media. The one or more non-transitory computer-readable media may store the one or more computer programs that include the instructions configured to perform the method.

An implementation of the present invention may encompass the computing system having the one or more processors and the storage media storing the one or more computer programs that include the instructions configured to perform the method.

An implementation of the present invention may encompass one or more virtual machines that operate on top of one or more computer systems and emulate virtual hardware. A virtual machine can be a Type-1 or Type-2 hypervisor, for example. Operating system virtualization using containers is also possible instead of, or in conjunction with, hardware virtualization with hypervisors.

For an implementation that encompasses multiple computer systems, the computer systems may be arranged in a distributed, parallel, clustered or other suitable multi-node computing configuration in which computer systems are continuously, periodically, or intermittently interconnected by one or more data communications networks (e.g., one or more internet protocol (IP) networks.) Further, it need not be the case that the set of computer systems that execute the instructions be the same set of computer systems that provide the storage media storing the one or more computer programs, and the sets may only partially overlap or may be mutually exclusive. For example, one set of computer systems may store the one or more computer programs from which another, different set of computer systems downloads the one or more computer programs and executes the instructions thereof.

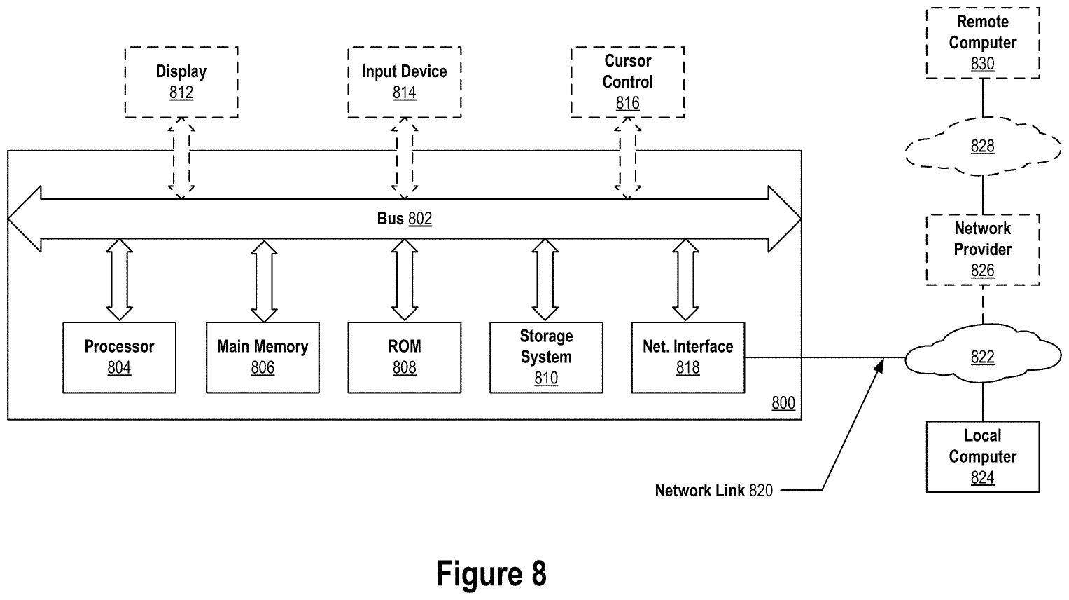

FIG. 8 is a block diagram of example computer system 800 used in an implementation of the present invention. Computer system 800 includes bus 802 or other communication mechanism for communicating information, and one or more hardware processors coupled with bus 802 for processing information.

Hardware processor 804 may be, for example, a general-purpose microprocessor, a central processing unit (CPU) or a core thereof, a graphics processing unit (GPU), or a system on a chip (SoC).

Computer system 800 also includes a main memory 806, typically implemented by one or more volatile memory devices, coupled to bus 802 for storing information and instructions to be executed by processor 804. Main memory 806 also may be used for storing temporary variables or other intermediate information during execution of instructions by processor 804.

Computer system 800 may also include read-only memory (ROM) 808 or other static storage device coupled to bus 802 for storing static information and instructions for processor 804.

A storage system 810, typically implemented by one or more non-volatile memory devices, is provided and coupled to bus 802 for storing information and instructions.

Computer system 800 may be coupled via bus 802 to display 812, such as a liquid crystal display (LCD), a light emitting diode (LED) display, or a cathode ray tube (CRT), for displaying information to a computer user. Display 812 may be combined with a touch sensitive surface to form a touch screen display. The touch sensitive surface may be an input device for communicating information including direction information and command selections to processor 804 and for controlling cursor movement on display 812 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 814, including alphanumeric and other keys, may be coupled to bus 802 for communicating information and command selections to processor 804.

Another type of user input device may be cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Instructions, when stored in non-transitory storage media accessible to processor 804, such as, for example, main memory 806 or storage system 810, render computer system 800 into a special-purpose machine that is customized to perform the operations specified in the instructions. Alternatively, customized hard-wired logic, one or more ASICs or FPGAs, firmware and/or hardware logic which in combination with the computer system causes or programs computer system 800 to be a special-purpose machine.

A computer-implemented process may be performed by computer system 800 in response to processor 804 executing one or more sequences of one or more instructions contained in main memory 806. Such instructions may be read into main memory 806 from another storage medium, such as storage system 810. Execution of the sequences of instructions contained in main memory 806 causes processor 804 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 810) and/or volatile media (e.g., main memory 806). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 802. Transmission media can also take the form of acoustic or light waves, such as those generated during radio-wave and infra-red data communications.

Computer system 800 also includes a network interface 818 coupled to bus 802. Network interface 818 provides a two-way data communication coupling to a wired or wireless network link 820 that is connected to a local, cellular or mobile network 822. For example, communication interface 818 may be IEEE 802.3 wired “ethernet” card, an IEEE 802.11 wireless local area network (WLAN) card, an IEEE 802.15 wireless personal area network (e.g., Bluetooth) card or a cellular network (e.g., GSM, LTE, etc.) card to provide a data communication connection to a compatible wired or wireless network. In an implementation, communication interface 818 sends and receives electrical, electromagnetic or optical signals that carry digital data streams representing various types of information.

Network link 820 typically provides data communication through one or more networks to other data devices. For example, network link 820 may provide a connection through network 822 to local computer system 824 that is also connected to network 822 or to data communication equipment operated by a network access provider 826 such as, for example, an internet service provider or a cellular network provider. Network access provider 826 in turn provides data communication connectivity to another data communications network 828 (e.g., the internet). Networks 822 and 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the networks 822 and 828, network link 820 and communication interface 818. In the internet example, a remote computer system 830 might transmit a requested code for an application program through network 828, network 822 and communication interface 818. The received code may be executed by processor 804 as it is received, and/or stored in storage device 810, or other non-volatile storage for later execution.

### CONCLUSION

In the foregoing detailed description, possible implementations of the present invention have been described with reference to numerous specific details that may vary from implementation to implementation. The detailed description and the figures are, accordingly, to be regarded in an illustrative rather than a restrictive sense.

Reference in the detailed description to an implementation of the present invention is not intended to mean that the implementation is exclusive of other disclosed implementations of the present invention, unless the context clearly indicates otherwise. Thus, a described implementation may be combined with one or more other described implementations in a particular implementation, unless the context clearly indicates that the implementations are incompatible. Further, the described implementations are intended to illustrate the present invention by example and are not intended to limit the present invention to the described implementations.

In the foregoing detailed description and in the appended claims, although the terms first, second, etc. are, in some instances, used herein to describe various elements, these elements should not be limited by these terms. These terms are only used to distinguish one element from another. For example, a first user interface could be termed a second user interface, and, similarly, a second user interface could be termed a first user interface, without departing from the scope of the various described implementations. The first user interface and the second user interface are both user interfaces, but they are not the same user interface.

As used in the foregoing detailed description and in the appended claims of the various described implementations, the singular forms “a,” “an,” and “the” are intended to include the plural forms as well, unless the context clearly indicates otherwise. As used in the foregoing detailed description and in the appended claims, the term “and/or” refers to and encompasses any and all possible combinations of one or more of the associated listed items.

As used in the foregoing detailed description in the appended claims, the terms “based on,” “according to,” “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

For situations in which implementations discussed above collect information about users, the users may be provided with an opportunity to opt in/out of programs or features that may collect personal information. In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized rather than associated with a particular user. For example, the user preferences or user interactions may be generalized based on user demographics.

1. A method performed by a computing system of an online service, the computing system having one or more processors and storage media, the storage media storing one or more computer programs, the one or more computer programs including instructions configured to perform the method and executed by the one or more processors to perform the method, the one or more processors and the storage media provided by one or more computer systems of the computing system, the method comprising:
during an experiment, causing a computer graphical user interface that includes a treatment feature to be displayed at computing devices for a first plurality of user accounts of the online service;
during the experiment, causing a computer graphical user interface that includes a control feature, but that does not include the treatment feature, to be displayed at computing devices for a second plurality of user accounts of the online service;
wherein, during the experiment, a plurality of messages is sent through the online service;
wherein each message, of the plurality of messages, is sent from a respective sender user account to a respective recipient user account; wherein the respective sender user account is a user account of either the first plurality of user accounts or the second plurality of user accounts;
wherein the respective recipient user account is a user account of either the first plurality of user accounts or the second plurality of user accounts; wherein the respective recipient user account is a user account other than the respective sender user account;
during the experiment, storing in computer storage media a plurality of records for the plurality of messages sent; and
based on the plurality of records, determining a first count of messages, of the plurality of messages, that were sent, during the experiment, between user accounts, of the first plurality of user accounts;
based on the plurality of records, determining a second count of messages, of the plurality of messages, that were sent, during the experiment, between user accounts, of the second plurality of user accounts;
based on the first count of messages and the second count of messages, estimating a total lift for the experiment; and
causing a graphical user interface to be displayed that presents the total lift estimated for the experiment.

2. The method of claim 1, further comprising:
estimating the total lift for the experiment based on the first count of messages normalized for a ramp percentage and based on the second count of messages normalized for a ramp percentage.

3. The method of claim 1, further comprising:
based on the plurality of records, determining a third count of messages, of the plurality of messages, that were sent, during the experiment, from user accounts, of the first plurality of user accounts, to user accounts, of the second plurality of user accounts;
based on the plurality of records, determining a fourth count of messages, of the plurality of messages, that were sent, during the experiment, from user accounts, of the second plurality of user accounts, to user accounts, of the first plurality of user accounts;
estimating a message response rate for the experiment based on all of: the first count of messages, the second count of messages, the third count of messages, and the fourth count of messages; and
causing a graphical user interface to be displayed that presents the message response rate estimated for the experiment.

4. The method of claim 1, further comprising:
based on the plurality of records, determining a third count of messages, of the plurality of messages that were sent, during the experiment, from user accounts, of the first plurality of user accounts, to user accounts, of the second plurality of user accounts;
based on the plurality of records, determining a fourth count of messages, of the plurality of messages that were sent, during the experiment, from user accounts, of the first plurality of control user accounts, to user accounts, of the second plurality of user accounts;
based on the first count of messages, the second count of messages, the third count of messages, and the fourth count of messages, estimating an instant lift for the experiment; and
causing a graphical user interface to be displayed that presents the instant lift estimated for the experiment.

5. The method of claim 1, further comprising:
during an iteration of a target permutation for variance estimation:
assigning a user account a same treatment status at each of a plurality of data processing nodes of a distributed data processing system based on a hash function, an identifier of the user account, and an identifier of the iteration; and
wherein the assigning the user account the same treatment status is performed at each of the plurality of data processing nodes without a data processing node of the plurality of data processing nodes communicating over a data communications network with another data processing node of the plurality of data processing node to perform the assigning.

6. The method of claim 1, wherein each record of the plurality of records stored during the experiment corresponds to a respective message of the plurality of messages sent; and wherein each record of the plurality of records stored during the experiment contains an identifier of a sending user account of the respective message and contains an identifier of an intended recipient user account of the respective message; and wherein the method further comprises:
after the plurality of records are stored:
for each record of the plurality of records, classifying the respective message as treatment-to-treatment, treatment-to-control, control-to-control, or control-to-treatment based on whether the sending user account of the respective message belongs to the first plurality of user accounts or the second plurality of user accounts and based on whether the recipient user account of the respective messages belongs to the first plurality of user accounts or the second plurality of user accounts; and
based on the classifying, determining the first count of messages based on a count of messages classified as treatment-to-treatment; and
based on the classifying, determining the second count of messages based on a count of messages classified as control-to-control.

7. The method of claim 1, wherein a ramp percentage of the experiment is fifty percent.

8. One or more non-transitory computer-readable media comprising:
one or more computer programs configured for execution by one or more processors and including instructions configured for:
during an experiment, causing a computer graphical user interface that includes a treatment feature to be displayed at computing devices for a first plurality of user accounts of an online service;
during the experiment, causing a computer graphical user interface that includes a control feature, but that does not include the treatment feature, to be displayed at computing devices for a second plurality of control user accounts of the online service;
wherein, during the experiment, a plurality of messages is sent through the online service;
wherein each message, of the plurality of messages, is sent from a respective sender user account to a respective recipient user account; wherein the respective sender user account is a user account of either the first plurality of user accounts or the second plurality of user accounts;
wherein the respective recipient user account is a user account of either the first plurality of user accounts or the second plurality of user accounts; wherein the respective recipient user account is a user account other than the respective sender user account;
during the experiment, storing in computer storage media a plurality of records for the plurality of messages sent; and
based on the plurality of records, determining a first count of messages, of the plurality of messages, that were sent, during the experiment, between user accounts, of the first plurality of user accounts;
based on the plurality of records, determining a second count of messages, of the plurality of messages, that were sent, during the experiment, between control user accounts, of the plurality of control user accounts, during the experiment;
based on the first count of messages and the second count of messages, estimating a total lift for the experiment; and
causing a graphical user interface to be displayed that presents the total lift estimated for the experiment.

9. The one or more non-transitory computer-readable media of claim 8, further comprising:
one or more computer programs configured for execution by one or more processors and including instructions configured for:
estimating the total lift for the experiment based on the first count of messages normalized for a ramp percentage and based on the second count of messages normalized for a ramp percentage.

10. The one or more non-transitory computer-readable media of claim 8, further comprising:
one or more computer programs configured for execution by one or more processors and including instructions configured for:
based on the plurality of records, determining a third count of messages, of the plurality of messages, that were sent, during the experiment, from user accounts, of the first plurality of user accounts, to user accounts, of the second plurality of user accounts;
based on the plurality of records, determining a fourth count of messages, of the plurality of messages, that were sent, during the experiment, from user accounts, of the second plurality of control user accounts, to user accounts, of the first plurality of treated user accounts;
estimating a message response rate for the experiment based on all of: the first count of messages, the second count of messages, the third count of messages, and the fourth count of messages; and
causing a graphical user interface to be displayed that presents the message response rate estimated for the experiment.

11. The one or more non-transitory computer-readable media of claim 8, further comprising:
one or more computer programs configured for execution by one or more processors and including instructions configured for:
based on the plurality of records, determining a third count of messages, of the plurality of messages that were sent, during the experiment, from user accounts, of the first plurality of user accounts, to user accounts, of the second plurality of user accounts;
based on the plurality of records, determining a fourth count of messages, of the plurality of messages that were sent, during the experiment, from user accounts, of the first plurality of user accounts, to user accounts, of the second plurality of user accounts;
based on the first count of messages, the second count of messages, the third count of messages, and the fourth count of messages, estimating an instant lift for the experiment; and
causing a graphical user interface to be displayed that presents the instant lift estimated for the experiment.

12. The one or more non-transitory computer-readable media of claim 8, further comprising:
one or more computer programs configured for execution by one or more processors and including instructions configured for:
during an iteration of a target permutation for variance estimation:
assigning a user account a same treatment status at each of a plurality of data processing nodes of a distributed data processing system based on a hash function, an identifier of the user account, and an identifier of the iteration; and
wherein the assigning the user account the same treatment status is performed at each of the plurality of data processing nodes without a data processing node of the plurality of data processing nodes communicating over a data communications network with another data processing node of the plurality of data processing node to perform the assigning.

13. The one or more non-transitory computer-readable media of claim 8, wherein each record of the plurality of records stored during the experiment corresponds to a respective message of the plurality of messages sent; and wherein each record of the plurality of records stored during the experiment contains an identifier of a sending user account of the respective message and contains an identifier of an intended recipient user account of the respective message; and wherein the one or more non-transitory computer-readable media further comprise:
one or more computer programs configured for execution by one or more processors and including instructions configured for:
after the plurality of records are stored:
for each record of the plurality of records, classifying the respective message as treatment-to-treatment, treatment-to-control, control-to-control, or control-to-treatment based on whether the sending user account of the respective message belongs to the first plurality of user accounts or the second plurality of user accounts and based on whether the recipient user account of the respective messages belongs to the first plurality of user accounts or the second plurality of user accounts; and
based on the classifying, determining the first count of messages based on a count of messages classified as treatment-to-treatment; and
based on the classifying, determining the second count of messages based on a count of messages classified as control-to-control.

14. The one or more non-transitory computer-readable media of claim 8, wherein a ramp percentage of the experiment is less than fifty percent.

15. A computing system comprising:
one or more processors;
storage media;
one or more computer programs stored in the storage media, configured for execution by the one or more processors, and including instructions configured for:
during an experiment, causing a computer graphical user interface that includes a treatment feature to be displayed at computing devices for a first plurality of user accounts of an online service;
during the experiment, causing a computer graphical user interface that includes a control feature, but does not include the treatment feature, to be displayed at computing devices for a second plurality of user accounts of the online service;
wherein, during the experiment, a plurality of messages is sent through the online service;
wherein each message, of the plurality of messages, is sent from a respective sender user account to a respective recipient user account; wherein the respective sender user account is a user account of either the first plurality of user accounts or the second plurality of user accounts;
wherein the respective recipient user account is a user account of either the first plurality of user accounts or the second plurality of user accounts; wherein the respective recipient user account is a user account other than the respective sender user account; during the experiment, storing in computer storage media a plurality of records for the plurality of messages sent; and
based on the plurality of records, determining a first count of messages, of the plurality of messages, that were sent, during the experiment, between user accounts, of the first plurality of user accounts;
based on the plurality of records, determining a second count of messages, of the plurality of messages, that were sent, during the experiment, between user accounts, of the second plurality of user accounts;
based on the first count of messages and the second count of messages, estimating a total lift for the experiment; and
causing a graphical user interface to be displayed that presents the total lift estimated for the experiment.

16. The computing system of claim 15, further comprising:
one or more computer programs stored in the storage media, configured for execution by the one or more processors, and including instructions configured for:
estimating the total lift for the experiment based on the first count of messages normalized for a ramp percentage and based on the second count of messages normalized for a ramp percentage.

17. The computing system of claim 15, further comprising:
one or more computer programs stored in the storage media, configured for execution by the one or more processors, and including instructions configured for:
based on the plurality of records, determining a third count of messages, of the plurality of messages, that were sent, during the experiment, from user accounts, of the first plurality of treated user accounts, to user accounts, of the second plurality of user accounts;
based on the plurality of records, determining a fourth count of messages, of the plurality of messages, that were sent, during the experiment, from user accounts, of the second plurality of control user accounts, to user accounts, of the first plurality of user accounts;
estimating a message response rate for the experiment based on all of: the first count of messages, the second count of messages, the third count of messages, and the fourth count of messages; and
causing a graphical user interface to be displayed that presents the message response rate estimated for the experiment.

18. The computing system of claim 15, further comprising:
one or more computer programs stored in the storage media, configured for execution by the one or more processors, and including instructions configured for:
based on the plurality of records, determining a third count of messages, of the plurality of messages that were sent, during the experiment, from user accounts, of the first plurality of user accounts, to user accounts, of the second plurality of user accounts;
based on the plurality of records, determining a fourth count of messages, of the plurality of messages that were sent, during the experiment, from user accounts, of the second plurality of user accounts, to user accounts, of the first plurality of user accounts;
based on the first count of messages, the second count of messages, the third count of messages, and the fourth count of messages, estimating an instant lift for the experiment; and
causing a graphical user interface to be displayed that presents the instant lift estimated for the experiment.

19. The computing system of claim 15, further comprising:
one or more computer programs stored in the storage media, configured for execution by the one or more processors, and including instructions configured for:
during an iteration of a target permutation for variance estimation:
assigning a user account a same treatment status at each of a plurality of data processing nodes of a distributed data processing system based on a hash function, an identifier of the user account, and an identifier of the iteration; and
wherein the assigning the user account the same treatment status is performed at each of the plurality of data processing nodes without a data processing node of the plurality of data processing nodes communicating over a data communications network with another data processing node of the plurality of data processing node to perform the assigning.

20. The computing system of claim 15, further comprising: wherein each record of the plurality of records stored during the experiment corresponds to a respective message of the plurality of messages sent; and wherein each record of the plurality of records stored during the experiment contains an identifier of a sending user account of the respective message and contains an identifier of an intended recipient user account of the respective message; and
wherein the computing further comprises:
one or more computer programs configured for execution by one or more processors and including instructions configured for:
after the plurality of records are stored:
for each record of the plurality of records, classifying the respective message as treatment-to-treatment, treatment-to-control, control-to-control, or control-to-treatment based on whether the sending user account of the respective message belongs to the first plurality of user accounts or the second plurality of user accounts and based on whether the recipient user account of the respective messages belongs to the first plurality of user accounts or the second plurality of user accounts;
based on the classifying, determining the first count of messages based on a count of messages classified as treatment-to-treatment; and
based on the classifying, determining the second count of messages based on a count of messages classified as control-to-control.
